(19) United States
(12) Patent Application Publication
(10) Pub. No.: US 2009/0244441 A1
(43) Pub. Date: Oct. 1, 2009

(54) DISPLAY DEVICE

(75) Inventors: Hitoshi NAGATO, Tokyo (JP); Rei HASEGAWA, Kanagawa-ken (JP); Haruhi OOOKA, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/397,762

(22) Filed: Mar. 4, 2009

(30) Foreign Application Priority Data
Mar. 25, 2008 (JP) 2008-077206

(51) Int. Cl. G02F 1/1347

(52) U.S. Cl. 349/78

(57) ABSTRACT

A display device includes a first switching layer switchable between a first color state and a translucent state, a second switching layer switchable between a second color state and a translucent state, a third switching layer switchable between a third color state and a translucent state, a first colored layer,a second colored layer, a third colored layer, and an intermediate layer provided between the first switching layer and the first colored layer. Mixing colors in the first color state, the second color state and the third color state produces achromatic color.

### CROSS-REFERENCE TO RELATED APPLICATIONS

This application is based upon and claims the benefit of priority from the prior Japanese Patent Application No. 2008-077206, filed on Mar. 25, 2008; the entire contents of which are incorporated herein by reference.

### BACKGROUND OF THE INVENTION

1. Field of the Invention

This invention relates to a display device.

2. Background Art

A liquid crystal display device used for various OA instruments, a portable terminal and a color television or the like includes a combination of backlight and a color filter, and suffers from display quality of poor visibility in bright-light other than large power consumption. Thus, a reflection type color display device is desired to be developed to have low power consumption and high quality display.

Use of a color filter to achieve reflection typed color display results in dark display to be a problem. As a method to perform color display without the color filter, a method laminating three layers of guest host liquid crystal in three colors of C(cyan), M(magenta), Y(yellow) is illustrated, however, extraction of wirings for driving a middle liquid crystal layer is difficult, namely a method for manufacturing is difficult. Moreover, laminating three layers causes increase of thickness and weight of the display device to be not practical.

On the other hand, JP-A 8-286215 (Kokai)(1996) discloses a liquid crystal element performing color display of two layers structure configured to combine a region of primary-colors guest host liquid crystal with a region of a complementary colors guest host liquid crystal. However, display performance such as contrast and brightness or the like is susceptible to improvement in even this configuration.

### SUMMARY OF THE INVENTION

According to an aspect of the invention, there is provided a display device including: a first switching layer switchable between a first color state and a translucent state; a second switching layer juxtaposed in the same plane as the first switching layer, switchable between a second color state and a translucent state independent of the first switching layer; a third switching layer juxtaposed in the same plane as the first switching layer, switchable between a third color state and a translucent state independent of the first switching layer and the second switching layer; a first colored layer laminated to the first switching layer, having a color serving as a complementary color with respect to a color in the first color state; a second colored layer laminated to the second switching layer in the same plane as the first colored layer, having a color serving as a complementary color with respect to a color in the second color state; a third colored layer laminated to the third switching layer in the same plane as the first colored layer, having a color serving as a complementary color with respect to a color in the third color state; and an intermediate layer provided between the first switching layer and the first colored layer, between the second switching layer and the second colored layer, and between the third switching layer and the third colored layer, switchable between a reflective state and a translucent state independent of the first switching layer, the second switching layer and the third switching layer, mixing colors in the first color state, the second color state and the third color state producing achromatic color.

### BRIEF DESCRIPTION OF THE DRAWINGS

FIG. 1 is a conceptual cross-sectional view illustrating the configuration of a display device according to a first embodiment of the invention;

FIGS. 2A to 2N are conceptual cross-sectional views illustrating operating states of the display device according to the first embodiment of the invention;

FIGS. 3A to 3E are conceptual views illustrating characteristics of the display device according to the first embodiment of the invention;

FIG. 4 is a conceptual schematic cross-sectional view illustrating the configuration of a display device according to a comparative example;

FIG. 5 is a conceptual cross-sectional view illustrating the configuration of another display device according to the first embodiment of the invention;

FIG. 6 is a conceptual cross-sectional view illustrating the configuration of a display device according to a second embodiment of the invention;

FIG. 7 is a conceptual cross-sectional view illustrating the configuration of another display device according to the second embodiment of the invention;

FIG. 8 is a schematic perspective view illustrating the configuration of a display device according to a third embodiment of the invention;

FIG. 9 is a schematic cross-sectional view illustrating the configuration of the display device according to the third embodiment of the invention;

FIG. 10 is a schematic cross-sectional view illustrating the configuration of another display device according to the third embodiment of the invention;

FIG. 11 is a schematic cross-sectional view illustrating the configuration of another display device according to the third embodiment of the invention;

FIG. 12 is a schematic cross-sectional view illustrating the configuration of another display device according to the third embodiment of the invention;

FIG. 13 is a schematic cross-sectional view illustrating the configuration of another display device according to the third embodiment of the invention;

FIG. 14 is a schematic cross-sectional view illustrating the configuration of another display device according to the third embodiment of the invention;

FIG. 15 is a conceptual cross-sectional view illustrating the configuration of a display device according to a fourth embodiment of the invention;

FIG. 16 is a schematic cross-sectional view illustrating the configuration of another display device according to the fourth embodiment of the invention; and

FIG. 17 is a schematic cross-sectional view illustrating the configuration of another display device according to the fourth embodiment of the invention.

### DETAILED DESCRIPTION OF THE INVENTION

An embodiment of the invention will now be described with reference to the drawings.

It is noted that figures are schematic and conceptual, the relationship between a thickness and a width of respective portions and size ratios between portions are not always identical with real ones. Even in the case where the same portions are shown, each other's dimensions and ratios may be shown differently depending on figures.

In the specification and respective figures, elements similar to those described with regard to previous figures are marked with the same reference numerals and not described in detail as necessary.

### First Embodiment

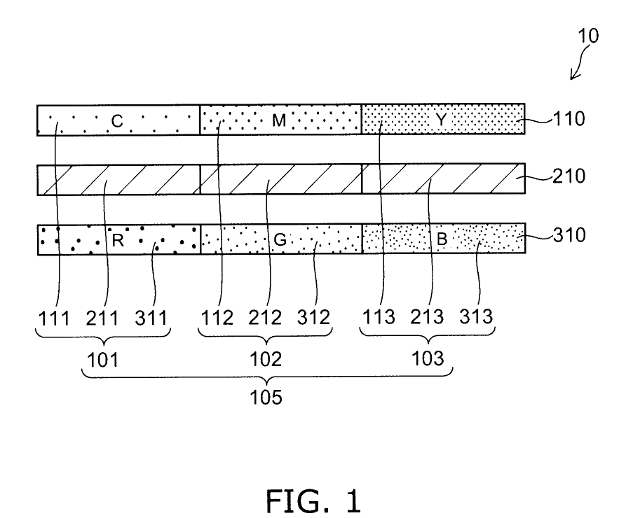

FIG. 1 is a conceptual cross-sectional view illustrating the structure of a display device according to a first embodiment of the invention.

As shown in FIG. 1, a display device 10 according to the first embodiment of the invention comprises a first display layer 110, a colored layer 310 and a second display layer (intermediate layer) 210 provided between them.

The first display layer 110 has a first switching layer 111, a second switching layer 112 and a third switching layer 113 juxtaposed in a layer plane of the first display layer 110. The first display layer 110 can be illustratively based on guest host liquid crystal. For example, the first switching layer 111 switches between cyan (C) and transparent (translucent state), the second switching layer 112 switches between magenta (M) and transparent, and the third switching layer 113 switches between yellow (Y) and transparent, and then these switches are set to be workable independent of one another.

Moreover, mixing colors of the first to third switching layers 111 to 113 in a color state produces achromatic color. Additionally, colors in the color state of respective switching layers may be exchanged each other in the above.

For example, the first to third switching layers 111 to 113 can be based on guest host liquid crystal mixing dichroic dye exhibiting respective colors of Y, M, C into liquid crystal having minus dielectric anisotropy, and can be based on liquid crystal layers orienting to a perpendicular direction to the colored layer without application of voltage and arranging from a perpendicular to parallel direction to the layer with application of voltage. In this case, when voltage of threshold voltage or higher is applied to the first to third switching layers 111 to 113, the layers exhibit coloring of C, M, Y, respectively and no voltage application results in transparent.

On the other hand, the second display layer 210 can be based on mixing layers of polymer and liquid crystal such as, for example, polymer dispersed liquid crystal (PDLC) and polymer network liquid crystal (PNLC) or the like. That is, the second display layer 210 switches between transparent (translucent state) and light scattering, namely a reflective state (white).

In the display device 10 illustrated in FIG. 1, the second display layer 210 has a fourth switching layer 211, a fifth switching layer 212 and a sixth switching layer 213 juxtaposed in a parallel plane to the second display layer 210, provided by laminating at positions corresponding to the above first switching layer 111, the second switching layer 112 and the third switching layer 113, respectively. And, for example, when no voltage is applied to the fourth to sixth switching layers 211 to 213, white color as the reflective state is exhibited, and voltage application results in transparent (translucent state).

That is, in the display device 10, the second display layer 210 has the fourth switching layer 211 provided between the first switching layer 111 and a first colored layer 311, switchable between the reflective state and the translucent state, a fifth switching layer 212 provided between the second switching layer 112 and a second colored layer 312, switchable between the reflective state and the translucent state independent of the fourth switching layer 211, and a sixth switching layer 213 provided between the third switching layer 113 and a third colored layer 313, switchable between the reflective state and the translucent state independent of the fourth switching layer 211 and the fifth switching layer 212.

Moreover, as described later, the fourth to sixth switching layers 211 to 213 may not always be three independent switching layers, and the second display layer 210 may be made up of a switching layer unifying the fourth to sixth switching layers (a seventh switching layer 214 described later).

In addition, the colored layer 310 can be illustratively based on various ink and paint. The colored layer 310 has the first colored layer 311, the second colored layer 312 and the third colored layer 313 juxtaposed in the identical plane and provided at positions corresponding to the above first switching layer 111, the second switching layer 112 and the third switching layer 113, respectively. For example, the first colored layer 311 can be set to red color (R), the second colored layer 312 can be set to green color (G) and the third colored layer 313 can be set to blue color (B). That is, the color of the first colored layer 311 is a complementary color of the first switching layer 111, the color of the second colored layer 312 is a complementary color of the second switching layer 112 and the color of the third colored layer 313 is a complementary color of the third switching layer 113.

Furthermore, the first to third colored layers 311 to 313 can improve brightness of the display device 10 by coloring and having reflectivity. In this case, while both mirror reflectivity and diffusion reflectivity are concerned, lowering the mirror reflectivity and increasing the diffusion reflectivity can preferably prevent reflection of light and image around the display device, and surrounding light can be effectively used for display. That is, the first to third colored layers 311 to 313 can take on the diffusion reflectivity. In addition, a reflecting layer not shown may be provided on the opposite side of the first to third colored layers 311 to 313 to the second display layer 210. In this case, this reflecting layer can take on the diffusion reflectivity.

That is, the display device 10 according to the embodiment comprises the first switching layer 111 switchable between a first color state and a translucent state, the second switching layer 112 juxtaposed in the same plane as the first switching layer 111, switchable between a second color state and a translucent state independent of the first switching layer 111, and the third switching layer 113 juxtaposed in the same plane as the first switching layer 111, switchable between a third color state and a translucent state independent of the first switching layer 111 and the second switching layer 112.

Moreover, the display device 10 further comprises the first colored layer 311 provided by laminating to the first switching layer 111, having the color serving as the complementary color with respect to the color in the first color state, the second colored layer 312 provided by laminating to the second switching layer 112 in the same plane as the first colored layer 311, having the color serving as the complementary color with respect to the color in the second color state, and the third colored layer 313 provided by laminating to the third switching layer 113 in the same plane as the first colored layer 311, having the color serving as the complementary color with respect to the color in the third color state.

Furthermore, the display device 10 further comprises the intermediate layer (the second display layer 210) provided between the first switching layer 111 and the first colored layer 311, between the second switching layer 112 and the second colored layer 312 and between the third switching layer 113 and the third colored layer 313, switchable between the reflective state and the translucent state independent of the first switching layer 111, the second switching layer 112 and the third switching layer 113.

Moreover, mixing colors in the first color state, the second color state and the third color state produces achromatic color.

As described above, the display device 10 has a two layers structure laminating two switching layers of the first display layer 110 and the second display layer 210, and has the configuration combined this with the colored layer 310. Moreover, as illustrated above, respective controls of applied voltage to the first to third switching layers 111 to 113 and applied voltage to the fourth to sixth switching layers 211 to 213 enable various colors to be displayed depending on a combination of a state of coloring or transparence in the first to third switching layers 111 to 113 and a state of white or transparence in the fourth to sixth switching layers 211 to 213. In addition, in the following, two values state of coloring and transparence and two values state of white and transparence are described for simplicity, but display of various intermediate colors is possible by setting their intermediate states, respectively.

A laminated portion of the first switching layer 111, the fourth switching layer 211 and the first colored layer 311 is taken as a first sub-picture element 101. Additionally, a laminated portion of the second switching layer 112, the fifth switching layer 212 and the second colored layer 312 is taken as a second sub-picture element 102. Further, a laminated portion of the third switching layer 113, the sixth switching layer 213 and the third colored layer 313 is taken as a third sub-picture element 103. Moreover, the first sub-picture element 101, the second sub-picture element 102 and the third sub-picture element 103 form one picture element 105.

Furthermore, areas of the first to third sub-picture elements 101 to 103 can be identical. That is, the first to third sub-picture elements 101 to 103 can have the one-third area of the sub-picture element 105.

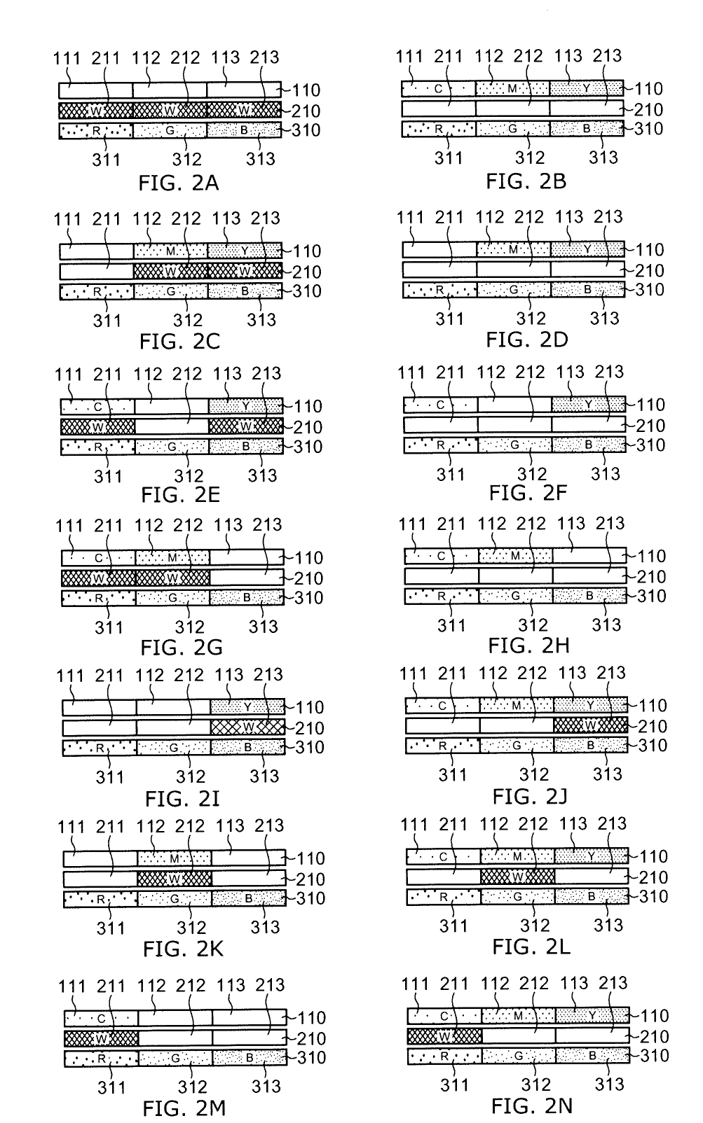

FIGS. 2A to 2N are conceptual cross-sectional views illustrating operating states of the display device according to the first embodiment of the invention.

In FIGS. 2A to 2N, characters “C”, “M” and “Y” in the first to third switching layers 111 to 113 show that the first to third switching layers 111 to 113 are colored to cyan (C), magenta (M) and yellow (Y) and no mark of characters indicates the translucent state. Moreover, character “W” in the fourth to sixth switching layers 211 to 213 indicates a white state and no mark indicates the translucent state.

As shown in FIG. 2A, all of the first to third switching layers 111 to 113 in the first display layer 110 are set to transparent, and the fourth to sixth switching layers 211 to 213 in the second display layer 210 are set to the white state. At this time, since the first display layer 110 is transparent, a viewer of the display device 10 views the second display layer 210. The second display layer 210 scatters the incident light from outside (upper direction presented on paper in the figure), and reflects diffusively surrounding light with a high reflectance and substantial uniformity to allow white to be displayed. In this way, the display device 10 can display bright white.

On the other hand, as shown in FIG. 2B, the first to third switching layers 111 to 113 of the first display layer 110 are set to color states of C, M and Y, respectively, and the fourth to sixth switching layers 211 to 213 of the second display layer 210 are set to the translucent state. At this time, the viewer views superimposed colors of the first display layer 110 upon colors of colored layers 310 provided on the backside. Since the first to third switching layers 111 to 113 of the first display layer 110 and the first to third colored layers 311 to 313 corresponding to each of the first to third switching layers 111 to 113 have complementary color relationships mutually, the first to third switching layers 111 to 113 and the first to third colored layers 311 to 313 absorb light in the whole range of visible light wave length and black is displayed. In this way, the display device 10 can paint dark black and high contrast display is possible.

In addition, display of white illustrated in FIG. 2A and display of black in FIG. 2B are switchable every each sub-picture element of the first to third sub-picture elements 101 to 103, respectively. This allows the display device 10 to exhibit high resolution display for displaying a monochrome image. That is, for example, in the display device having one picture element including three sub-picture elements RGB using color filters RGB, white and black are displayed every picture element including three sub-picture elements for displaying white and black. On the other hand, the display device 10 according to the embodiment can display white and black in the respective first to third sub-picture elements 101 to 103, and exhibiting three times resolution per one picture element is possible for displaying a monochrome image.

FIGS. 2C to 2N illustrate operating states of the display device 10 for displaying various colors. That is, FIGS. 2C, 2D correspond to display of red (R), FIGS. 2E, 2F to display of green (G), FIG. 2G, 2H to display of blue (B), FIGS. 2I, 2J to display of yellow (Y), FIGS. 2K, 2L to display of magenta (M), FIGS. 2M, 2N to display of cyan (C), respectively. As shown in these figures, the display device 10 according to the embodiment can be operated based on respective two kinds of states for displaying each color of red (R), green (G), blue (B), yellow (Y), magenta (M), cyan (C).

For example, as shown in FIG. 2C, the first switching layer 111 of the first display layer 110 and the fourth switching layer 211 of the second display layer 210 are set to transparent, and thereby the viewer views the first colored layer 311 (R). This presents R color. Moreover, the second switching layer 112 (M) and the third switching layer 113 (Y) of the first display layer 110 is colored, and the fifth switching layer 212 and the sixth switching layer 213 of the second display layer 210 thereunder are set to white. This also presents the R color by mixing M color and Y color of the first display layer 110. In this way, the operating state illustrated in FIG. 2C can display the R color. The displayed color in this case is the highly bright R color.

On the other hand, as shown in FIG. 2D, the first switching layer 111 of the first display layer 110 and the fourth switching layer 211 of the second display layer 210 are set to transparent, and thereby the viewer views the first colored layer 311 (R). This presents the R color. Moreover, the second switching layer 112 and the third switching layer 113 of the first display layer 110 are colored and the fifth switching layer 212 and the sixth switching layer 213 of the second display layer 210 are set to transparent, and thereby the light transmitting the second switching layer 112 (M) and the light transmitting the third switching layer 113 (Y) are absorbed by the second colored layer 312 (G) and the third colored layer 313 to be in a state of black. In other words, the first sub-picture element 101 present the R color and the second and third sub-picture elements 102, 103 present black, and consequently the R color is displayed. The R color in this case has a high chroma.

As described above, the display device 10 according to the embodiment can display the R color of the high brightness and the R color of the high chroma based on the above two operating states.

Similarly, as shown in FIG. 2E, the first switching layer 111 is set to the color state, the fourth switching layer 211 is set to the white state, and thereby C color is achieved. The second switching layer 112 is set to the translucent state, the fifth switching layer 212 is set to the translucent state, and thereby G color is achieved. The third switching layer 113 is set to the color state, the sixth switching layer 213 is set to the white state, and thereby the Y color is achieved. Consequently, in the picture element 105 having the first to third sub-picture elements 101 to 103, these colors are mixed and the G color of the high brightness can be displayed.

As shown in FIG. 2F, the first switching layer 111 is set to the color state, the fourth switching layer 211 is set to the translucent state, and thereby the black state is achieved. The second switching layer 112 and the fifth switching layer 212 are set to the translucent state, and thereby the G color is achieved. Moreover, the third switching layer 113 is set to the color state, the sixth switching layer 213 is set to the translucent state, and thereby the black state is achieved. Consequently, in the picture element 105 having the first to third sub-picture elements 101 to 103, these colors are mixed and the G color of the high chroma can be displayed.

Similarly, as shown in FIG. 2G, the first switching layer 111 is set to the color state, the fourth switching layer 211 is set to the white state, and thereby the C color is achieved. The second switching layer 112 is set to the color state, the fifth switching layer 212 is set to the white state, and thereby the M color is achieved. Moreover, the third switching layer 113 and the sixth switching layer 213 are set to the translucent state and thereby B color is achieved. Consequently, in the picture element 105 having the first to third sub-picture elements 101 to 103, these colors are mixed and the B color of the high brightness can be displayed.

As shown in FIG. 2H, the first switching layer 111 is set to the color state, the fourth switching layer 211 is set to the translucent state, and thereby the black state is achieved. The second switching layer 112 is set to the color state, the fifth switching layer 212 is set to the translucent state, and thereby the black state is achieved. Moreover, the third switching layer 113 and the sixth switching layer 213 are set to the translucent state, and thereby the B color is achieved. Consequently, in the picture element 105 having the first to third sub-picture elements 101 to 103, these colors are mixed and the B color of the high chroma can be displayed.

Similarly, as shown in FIG. 2I, the first switching layer 111 and the fourth switching layer 211 are set to the translucent state and thereby the R color is achieved. The second switching layer 112 and the fifth switching layer 212 are set to the translucent state, and thereby the G color is achieved. Moreover, the third switching layer 113 is set to the color state, the sixth switching layer 213 is set to the white state, and thereby the Y color is achieved. Consequently, in the picture element 105 having the first to third sub-picture elements 101 to 103, these colors are mixed and the Y color of the high brightness can be displayed.

Moreover, as shown in FIG. 2J, the first switching layer 111 is set to the color state, the fourth switching layer 211 is set to the translucent state, and thereby the black state is achieved. The second switching layer 112 is set to the color state, the fifth switching layer 212 is set to the translucent state, and thereby the black state is achieved. Moreover, the third switching layer 113 is set to the color state, the sixth switching state 213 is set to the white state, and thereby the Y color is achieved. Consequently, in the picture element 105 having the first to third sub-picture elements 101 to 103, these colors are mixed and the Y color of the high chroma can be displayed.

Similarly, as shown in FIG. 2K, the first switching layer 111 and the fourth switching layer 211 are set to the translucent state and thereby the R color is achieved. The second switching layer 112 is set to the color state, the fifth switching layer 212 is set to the white state, and thereby the M color is achieved. Moreover, the third switching layer 113 and the six switching layer 213 are set to the translucent state, and thereby the B color is achieved. Consequently, in the picture element 105 having the first to third sub-picture elements 101 to 103, these colors are mixed and the M color of the high brightness can be displayed.

Moreover, as shown in FIG. 2L, the first switching layer 111 is set to the color state, the fourth switching layer 211 is set to the translucent state, and thereby the black state is achieved. The second switching layer 112 is set to the color state, the fifth switching layer 212 is set to the white state, and thereby the M color is achieved. Moreover, the third switching layer 113 is set to the color state, and the sixth switching layer 213 is set to the translucent state, and thereby the black state is achieved. Consequently, in the picture element 105 having the first to third sub-picture elements 101 to 103, these colors are mixed and the M color of the high chroma can be displayed.

Similarly, as shown in FIG. 2M, the first switching layer 111 is set to the color state, the fourth switching layer 211 is set to the white state, and thereby the C color is achieved. The second switching layer 112 and the fifth switching layer 212 are set to the translucent state and thereby the G color is achieved. Moreover, the third switching layer 113 and the sixth switching layer 213 are set to the translucent state and thereby the B color is achieved. Consequently, in the picture element 105 having the first to third sub-picture elements 101 to 103, these colors are mixed and the C color of the high brightness can be displayed.

Moreover, as shown in FIG. 2N, the first switching layer 111 is set to the color state, the fourth switching layer 211 is set to the white state, and thereby the C color is achieved. The second switching layer 112 is set to the color state, the fifth switching layer 212 is set to the translucent state, and thereby the black state is achieved. Moreover, the third switching layer 113 is set to the color state, the sixth switching layer 213 is set to the translucent state, and thereby the black state is achieved. Consequently, in the picture element 105 having the first to third sub-picture elements 101 to 103, these colors are mixed and the C color of the high chroma can be displayed.

As described above, the display device 10 according to the embodiment can display each color of R, G, B, C, M and Y based on respective two operating states.

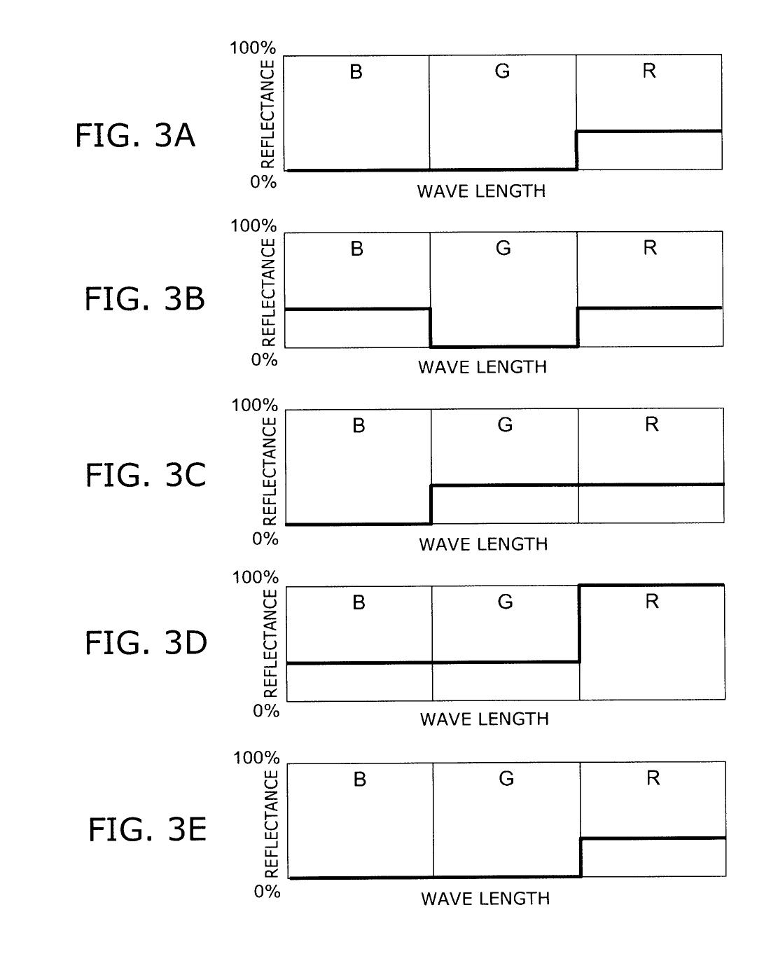

FIGS. 3A to 3E are conceptual views illustrating characteristics of the display device according to the first embodiment of the invention.

That is, FIGS. 3A to 3C illustrate reflection characteristics of the first sub-picture element 101, the second sub-picture element 102 and the third sub-picture element 103 in the operating state illustrated in FIG. 2C. FIG. 3D illustrates combined reflection characteristics of the picture element 105 having the first to third sub-picture elements 101 to 103 in the operating state illustrated in FIG. 2C. Moreover, FIG. 3E illustrates combined reflection characteristics of the picture element 105 having the first to third sub-picture elements 101 to 103 in the operating state illustrated in FIG. 2D.

In these figures, the horizontal axis represents a wave length and the vertical axis represents the reflectance. In addition, these reflection characteristics are schematically indicated as ideal ones.

As shown in FIG. 3A, in the operating state illustrated in FIG. 2C, the reflection characteristic of the first sub-picture element 101 is the characteristic of the R color serving as the color of the first colored layer 311. Here, since the area of the first sub-picture element 101 is ⅓ of that of one picture element 105, the reflection characteristic of the first sub-picture element 101, being regarded as one picture element, has the reflectance of about 33% in the wave length range of the R color and the reflectance of zero in the wave length range of the B color and the G color.

Moreover, as shown in FIG. 3B, in the operating state illustrated in FIG. 2C, the reflection characteristic of the second sub-picture element 102 is the characteristic of the M color of the second switching layer 112, and being regarded as one picture element, has the reflectance of about 33% in the wave length range of the B color and R the color and the reflectance of zero in the wave length range of the G color.

Moreover, as shown in FIG. 3C, in the operating state illustrated in FIG. 2C, the reflection characteristic of the third sub-picture element 103 is the characteristic of the Y color of the third switching layer 113, and being regarded as one picture element, has the reflectance of about 33% in the wave length range of the G color and the R color and the reflectance of zero in the wave length range of the B color.

As described above, in the operating state illustrated in FIG. 2C, the first to third sub-picture elements 101 to 103 display the R color, the M color and the Y color, respectively, and any sub-picture elements reflect the light in the wave length range of the R color.

As a result, as shown in FIG. 3D, the combined reflection characteristic of the one picture element 105 combining the reflection characteristics of the above first to third sub-picture elements 101 to 103 has the reflectance of 100% in the wave length range of the R color. In the wave length range of the B color and the G color, the reflection characteristic of the second sub-picture element 102 or the third sub-picture element 103 has the reflectance of about 33%.

That is, in the operating state illustrated in FIG. 2C of the display device 10 according to the embodiment, the reflectance in the wave length range of the R color is equivalent to the case where all of three sub-picture elements comprising one picture element are colored to the R color, and bright display can be achieved. The brightness of display in this case is close to that of the display device having three layers lamination structure laminating three liquid crystal layers of Y, M, C, and the display device 10 can display the bright R color comparable to the display device having the three layers structure, even though it has the two layers structure.

On the other hand, in the operating state of FIG. 2D, the reflection characteristic of the first sub-picture element 101 is the characteristic of the R color serving as the color of the first colored layer 311. That is, the reflection characteristic of the first sub-picture element 101 has the reflectance of about 33% in the wave length range of the R color and the reflectance of zero in the wave length range of the B color and the G color. The second sub-picture element 102 has the second switching layer 112 (M color) and the second colored layer 312 (G color) combined to display black. Similarly, the third sub-picture element 103 has the third switching layer 113 (Y color) and the third colored layer 313 (B color) combined to display black.

As a result, as shown in FIG. 3E, the combined reflection characteristic of the sub-picture element 105 having the first to third sub-picture elements 101 to 103 in the operating states of FIG. 2D has the reflectance of about 33% in the wave length range of the R color and the reflectance of zero in the wave length range of the B color and the G color.

That is, as compared with the reflection characteristic in the operating state illustrated in FIG. 3D, the brightness is low, but the R color of the high chroma illustrated in FIG. 3E can be displayed.

As described above, the display device 10 according to the embodiment can display the R color of the high brightness illustrated in FIG. 3D and the R color of the high chroma illustrated in FIG. 3E.

Similarly, with regard to the G color, the B color, the Y color, the M color and the C color illustrated in FIGS. 2E to 2N, displaying with the high brightness and displaying with the high chroma can be achieved for respective colors.

Moreover, an intermediate state between the color state and the translucent state of the first to third switching layers 111 to 113 of the first to third sub-picture elements 101 to 103 is combined with an intermediate state between the white state and the translucent state of the fourth to sixth switching layers 211 to 213, respectively and thereby various intermediate colors can be displayed.

### COMPARATIVE EXAMPLE

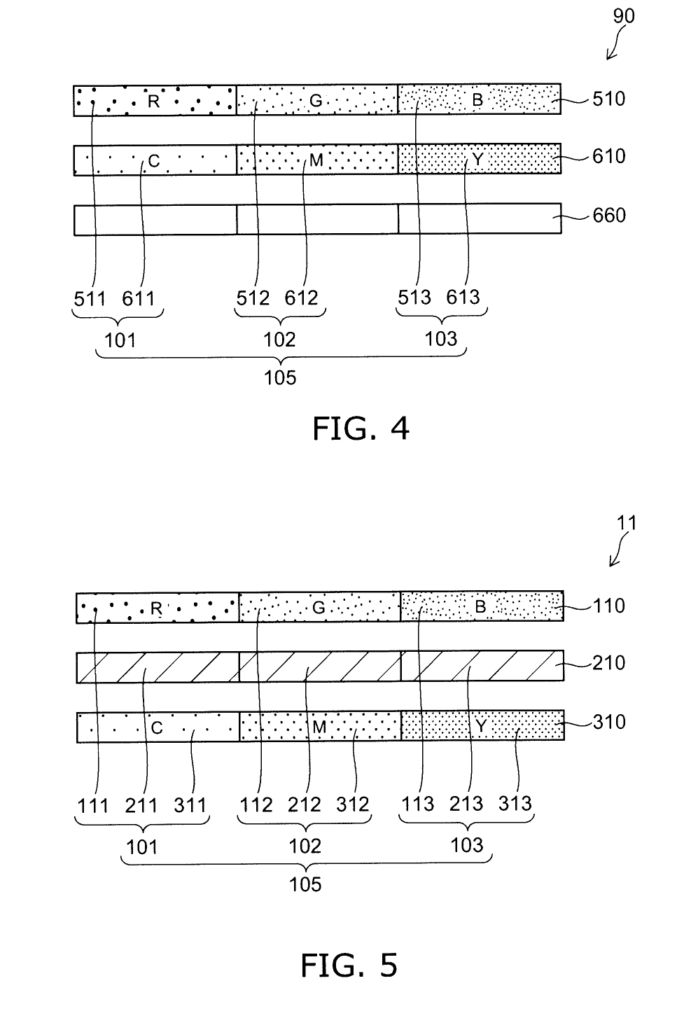

FIG. 4 is a conceptual schematic cross-sectional view illustrating the configuration of a display device according to a comparative example.

As shown in FIG. 4, a display device 90 of the comparative example has a two layers structure including a first display layer 510 and a second display layer 610.

Moreover, guest host liquid crystal is used for both the first display layer 510 and the second display layer 610. That is, a first switching layer 511 of the first display layer 510 is a guest host liquid crystal layer of the R color, a second switching layer 512 is a guest host liquid crystal layer of the G color and a third switching layer 513 is a guest host liquid crystal layer of the B color. A switching layer 611 of the second display layer 610 is a guest host liquid crystal layer of the C color, a fifth switching layer 612 is a guest host liquid crystal layer of the M color and a sixth switching layer 613 is a guest host liquid crystal layer of the Y color.

Moreover, the first sub-picture element 101 comprises the first switching layer 511 and the fourth switching layer 611, the second sub-picture element 102 comprises the second switching layer 512 and the fifth switching layer 612 and the third sub-picture element 103 comprises the third switching layer 513 and the sixth switching layer 613.

That is, each sub-picture element of the first to third sub-picture elements 101 to 103 has the complementary color relationship among respective switching layers of the first display layer 510 and the second display layer 610. Moreover, each of the first to sixth switching layers 511 to 513 and 611 to 613 can be switched between the color state and the translucent state.

On a backside of the second display layer 610 (opposite side to the first display layer 510), for example, a white diffusive reflecting layer 660 is provided.

This configuration enables the display device 90 of the comparative example to display various colors.

That is, all of the first to sixth switching layers 511 to 513, 611 to 613 are set to the color state and thereby the black state is achieved. All of the first to sixth switching layers 511 to 513, 611 to 613 are set to the translucent state and thereby the reflecting layer 660 is viewed. It is considered that the white state can be ideally displayed.

For example, all of the fourth to sixth switching layers 611 to 613 are set to the translucent state and the first to third switching layers 511 to 513 are colored, and thereby each color of R, G, and B, and their intermediate colors can be displayed. Moreover, all of the first to third switching layers 511 to 513 are set to the translucent state and the fourth to sixth switching layers 611 to 613 are colored, and thereby each color of C, M and Y, and their intermediate colors can be displayed. Furthermore, various combinations of the color states of the first to sixth switching layers 511 to 513 and the color states of the fourth to sixth switching layers 611 to 613 enables various colors to be displayed.

Here, there is a limit in improving order parameters of the guest host liquid crystal layers used for the first to sixth switching layers 511 to 513, 611 to 613. Therefore, the translucent state of the guest host liquid crystal layers is pale in residual color, although the color is light compared with the color state.

That is, the first to third switching layers 511 to 513 of the first display layer 510 are pale in residual color, even though being in the translucent state. Moreover, the fourth to sixth switching layers 611 to 613 of the second display layer are also pale in residual color, even though being in the translucent state.

Therefore, in the case where the first display layer 510 and the second display layer 610 are laminated, these residual pale colors are synergistic and color strength increases. Consequently, even if all of the first to sixth switching layers 511 to 513, 611 to 613 are set to the translucent state, they are practically pale in residual color, and this residual color is viewed as coloring, and thus the bright white state can not be displayed. That is, dark display is produced.

It is noted that, in the above, also in the case where the first to third switching layers 511 to 513 are taken as switching layers between the color state of C, M, Y and the translucent state, respectively and the fourth to sixth switching layers 611 to 613 are taken as switching layers between the color state of R, G, B and the translucent state, respectively, since two layers guest host liquid crystal is used, the above problem of residual pale color occurs similarly.

In contrast, the display device 10 according to the embodiment has the same two layers structure as the comparative example, but the guest host liquid crystal layer can be used for only the first display layer 110, and polymer dispersed liquid crystal can be used for the second display layer 210. That is, since only one layer of the guest host liquid crystal layer having the above problem of residual pale color is used, the problem of residual pale color can be within a practically acceptable range. This allows display of the bright white state in comparison with the comparative example. The display device 10 allows both white characteristic to reflectance (high brightness) and black characteristic to high contrast (high absorption of light) to be displayed, and allows color reproduction in the substantially same range as the display device having the three layers laminating structure.

As described above, the display device 10 according to the embodiment provides the reflective display device having the two layers structure achieving bright display with low power consumption and high contrast.

Moreover, the first display layer 110 is illustratively based on the guest host liquid crystal layer, however is not limited to this, the first display layer 110 may be favorably switched between the color state and the translucent state, and, for example, various principles of electro-optic layers such as electrophoresis, electro-powder fluid, electro-wetting or the like can be used.

Moreover, the first display layer 210 is illustratively based on the polymer dispersed liquid crystal layer, however is not limited to this, the first display layer 210 may be favorably switched between the color state and the translucent state. For example, a liquid crystal layer made of mixed fine particles, being dispersive without the voltage application and showing translucency with the voltage application, may be used. Moreover, a diffraction grating liquid crystal layer based on liquid crystal arranging in different directions in a micro space by applying voltage using a plurality of fine electrodes may be used. Furthermore, other than these liquid crystals, various principles of electro-optic layers such as electrophoresis, electro-powder fluid, electro-wetting or the like can be used.

FIG. 5 is a conceptual cross-sectional view illustrating the configuration of another display device according to the first embodiment of the invention.

As shown in FIG. 5, another display device 11 according to the first embodiment of the invention is different in colors of the first to third switching layers 111 to 113 and the first to third colored layers 311 to 313 from the display device 10 illustrated in FIG. 1. That is, the first switching layer 111 switches between the R color and transparent, the second switching layer 112 switches between the G color and transparent and the third switching layer 113 switches between the B color and transparent. Moreover, the first colored layer 311 is C in color, the second colored layer 312 is M in color and the third colored layer 313 is Y in color. Other components may be similar to the display device 10, thus the detailed description thereof is omitted.

Also in the display device 11, all of the first to third switching layers 111 to 113 are set to transparent and the fourth to sixth switching layers 211 to 213 are set to the white state, and thereby the bright white can be displayed. The first to third switching layers 111 to 113 are set to the color states of R, G and B, respectively and the fourth to sixth switching layers 211 to 213 of the second display layer 210 are set to the translucent state, and thereby the dark black can be painted, and display of high contrast is possible.

Furthermore, various colors can be displayed depending on the states of the first to third switching layers 111 to 113 and the states of the fourth to sixth switching layers 211 to 213. As described previously in the display device 10, the color of the high brightness and the color of the high chroma can be displayed with regard to the identical color. Moreover, the color of the high brightness has the brightness equivalent to the display device having the three layers structure.

As described above, the another display device 11 according to the embodiment also provides the reflective display device having the two layers structure achieving bright display with low power consumption and high contrast.

The colors of the respective color states of the first to third switching layers 111 to 113 may be achromatic for mixing these colors. Moreover, since the colors of the first to third colored layers 311 to 313 have the complementary relationship with the colors of color states of the first to third switching layers 111 to 113, respectively, in the case where the colors of the first to third switching layers 111 to 113 are changed, the colors of the first to third colored layers 311 to 313 may be coupled with them to be changed.

### Second Embodiment

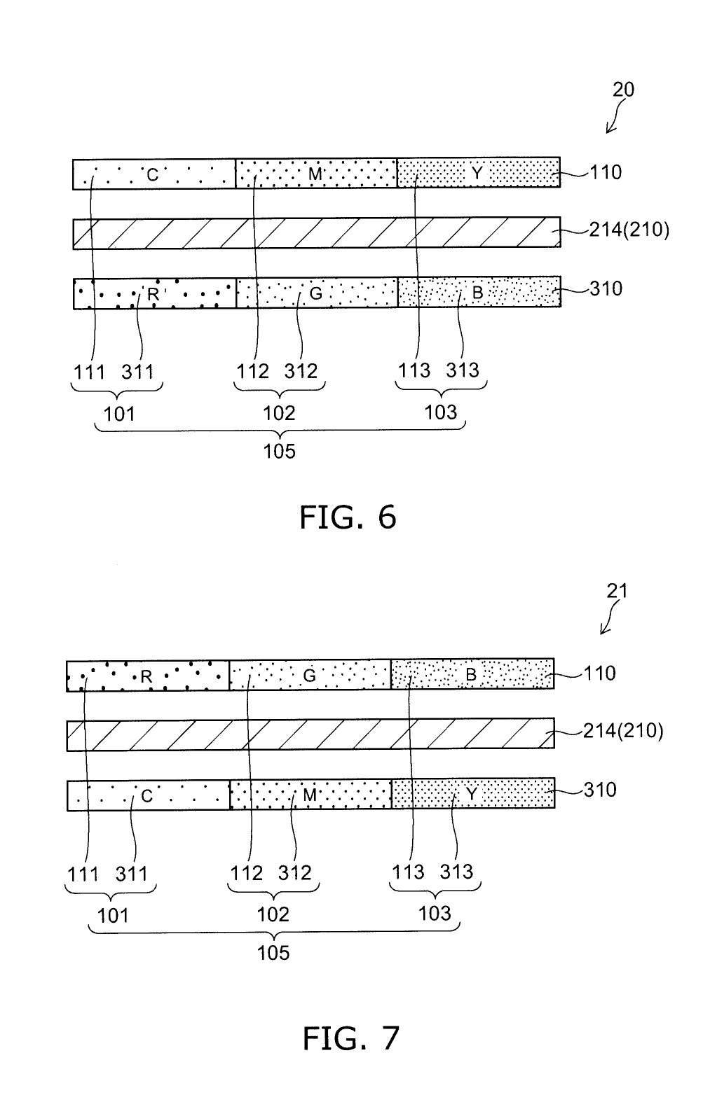

FIG. 6 is a conceptual cross-sectional view illustrating the configuration of a display device according to a second embodiment of the invention.

As shown in FIG. 6, a display device 20 according to the second embodiment of the invention is an example that the fourth to sixth switching layers 211 to 213 of the second display layer 210 in the display device 10 shown in FIG. 1 serve as the seventh switching layer 214 of one switching layer. Other components may be similar to the display device 10, thus the description thereof is omitted.

Also in the display device 20, all of the first to third switching layers 111 to 113 are set to transparent and the seventh switching layer 214 is set to the state of white, and thereby the bright white can be displayed. Moreover, the first to third switching layers 111 to 113 are set to the color states of C, M and Y, respectively and the seventh switching layer 214 is set to the translucent state, and thereby the dark black can be painted and display of high contrast is possible.

Furthermore, as described previously, in the display device 10, the fourth to sixth switching layers 211 to 213 can be switched each other independently, thus the respective first to third sub-picture elements 101 to 103 can be set to white or black independently, and monochrome display with a high resolution has been possible. On the contrary, in the display device 20, the second display layer 210 is having the seventh switching layer 214 of one switching layer, thus display of white or black is performed every picture element 105 having the first to third sub-picture elements 101 to 103. Therefore, the display device 20 has a lower resolution of monochrome display than the display device 10. However, whereas the display device 10 needs three sets of electrodes and switching elements for driving the fourth to sixth switching layers 211 to 213 every one picture element 105, the display device 20 needs only one set every one picture element, therefore, the display device 20 has an advantage of easy manufacturing.

Although the display device 20 according to the embodiment has the two layers structure, it can achieve the brightness of white and the darkness of black equivalent to the display device having the three layers structure.

As described above, the another display device 20 according to the embodiment also provides the reflective display device having the two layers structure achieving bright display with low power consumption and high contrast.

FIG. 7 is a conceptual cross-sectional view illustrating the configuration of another display device according to the second embodiment of the invention.

As shown in FIG. 7, another display device 21 according to the second embodiment of the invention has different colors of the first to third switching layers 111 to 113 and the first to third colored layers 311 to 313 from the display device 20 illustrated in FIG. 6. That is, the first switching layer 111 switches between the R color and transparent, the second switching layer 112 switches between the G color and transparent and the third switching layer 113 switches the B color and transparent. Moreover, the first colored layer 311 is C in color, the second colored layer 312 is M in color and the third colored layer 313 is Y in color. Other components may be similar to the display device 20, thus the description thereof is omitted.

Also in the display device 21, all of the first to third switching layers 111 to 113 are set to transparent and the seventh switching layer 214 is set to the white state, and thereby the bright white can be displayed. Moreover, the first to third switching layers 111 to 113 are set to the color states of R, G and B, respectively and the seventh switching layer 214 is set to the translucent state, and thereby the dark black can be painted and display of high contrast is possible. Also in the display device 21 having the two layers structure, it can achieve the brightness of white and the darkness of black equivalent to the display device having the three layers structure.

Moreover, various colors can be displayed depending on the states of the first to third switching layers 111 to 113 and the state of the seventh switching layer 214.

As described above, the another display device 21 according to the embodiment also provides the reflective display device having the two layers structure achieving bright display with low power consumption and high contrast.

### Third Embodiment

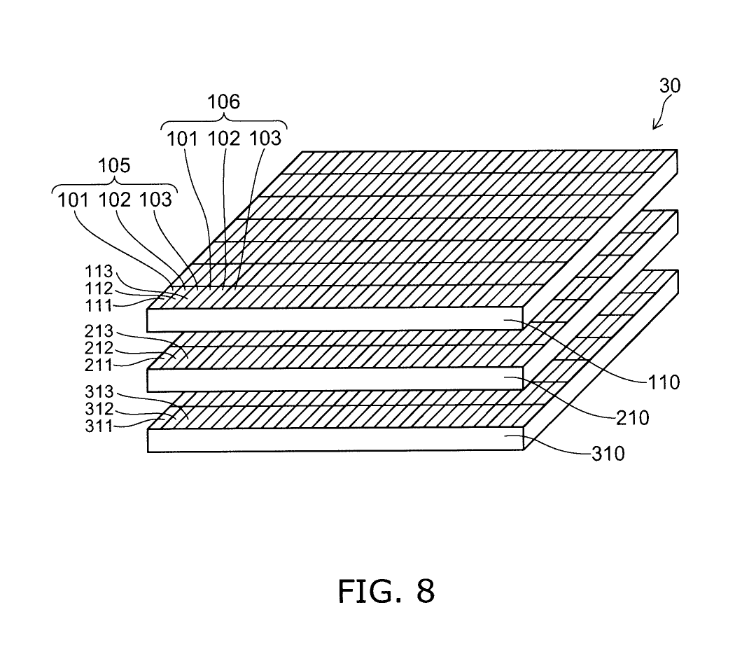

FIG. 8 is a schematic perspective view illustrating the configuration of a display device according to a third embodiment of the invention.

As shown in FIG. 8, in a display device 30 according to the embodiment, the above first to third sub-picture elements 101 to 103 form one picture element 105, and the plurality of picture elements 105 are juxtaposed in a matrix. This achieves a matrix type display device allowing display of any characters and figures.

An array order of the first to third sub-picture elements 101 to 103 of the picture element 105 is retained and the first to third sub-picture elements 101 to 103 are arranged. That is, as illustrated in FIG. 8, in each picture element 105, the second sub-picture element 102 is juxtaposed adjacent to the first sub-picture element 101, and the third sub-picture element 103 is juxtaposed adjacent to the opposite side of the second sub-picture element 102 to the first sub-picture element 101. Moreover, the first sub-picture element 101 of the next picture element 106 juxtaposed adjacent to the third sub-picture element 103 of the specific picture element is juxtaposed adjacent to the third sub-picture element 103 of the specific picture element 105.

In the display device 30 illustrated in FIG. 8, while the second display layer 210 has the fourth to sixth switching layers 211 to 213 switchable each other independently, as described previously, the second display layer 210 may be taken as the seventh switching layer 214 switchable between the reflective state and the translucent state every picture element 105.

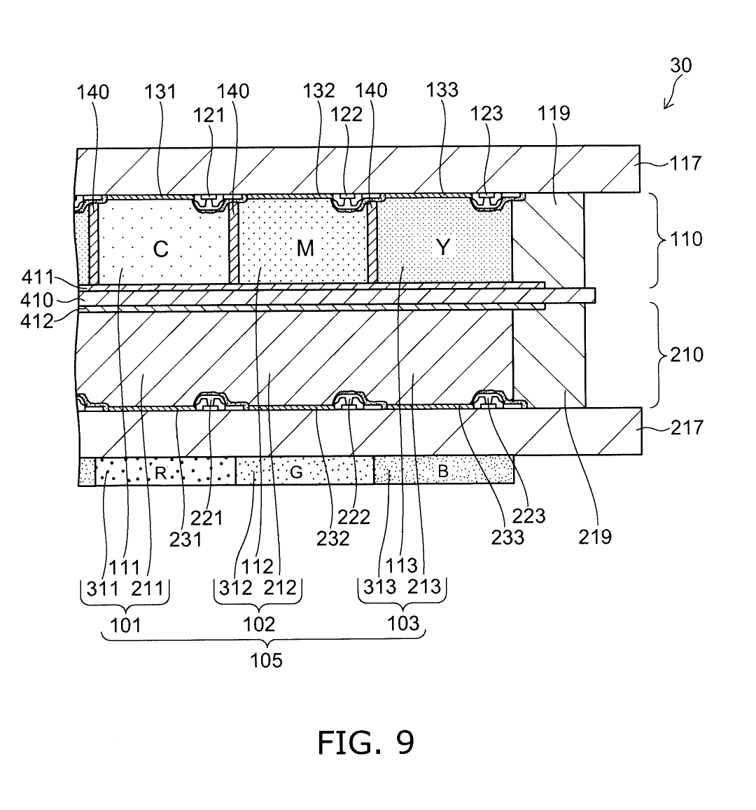

FIG. 9 is a schematic cross-sectional view illustrating the configuration of the display device according to the third embodiment of the invention.

That is, FIG. 9 illustrates a principal portion of the display device 30 according to the third embodiment of the invention.

As shown in FIG. 9, the display device 30 is provided with a first picture element electrode 131 and a first switching element 121 connected to it, a second picture element electrode 132 and a second switching element 122 connected to it, and a third picture element electrode 133 and a third switching element 123 connected to it on an upper surface of a first substrate 117 (lower surface presented on paper in the figure).

The first substrate 117 can be illustratively based on a glass substrate with translucency. However, the substrate is not limited to this and may be based on resin material or the like with translucency.

The first to third picture element electrodes 131 to 133 can be based on a transparent electrode such as ITO (Indium Tin Oxide) or the like. The first to third switching elements 121 to 123 can be illustratively based on a thin film transistor using amorphous silicon, polysilicon and micro-crystal silicon or the like as an active layer.

An intermediate member 410 is provided on the first to third picture element electrodes 131 to 133 side of the first substrate 117. The intermediate member 410 can be illustratively based on the glass substrate with translucency, but may be based on resin material with translucency. Moreover, as described later, an insulating thin film may be used.

A first counter electrode 411 is provided on a side facing the first substrate 117 of the intermediate member 410. The first counter electrode 411 can be illustratively based on ITO with translucency.

The first to third switching layers 111 to 113 are provided between the first to third picture element electrodes 131 to 133 of the first substrate 117 and the first counter electrode 411, respectively. As described previously, the first to third switching layers 111 to 113 can be illustratively based on the guest host liquid crystal layer of combination of three colors C, M, Y. In the display device 30 illustrated in FIG. 9, a dividing wall 140 is provided between respective layers among the first to third switching layers to isolate them each other, and the guest host liquid crystal layers of respective colors are provided at positions corresponding to the first to third picture element electrodes 131 to 133 isolated by the dividing walls 140.

The electrical potential supplied to the first to third picture element electrodes 131 to 133 through the first to third switching elements 121 to 123 and the potential difference (voltage) between the first counter electrode 411 and them produce voltage which is applied to the guest host liquid crystal layers of the first to third switching layers 111 to 113, and the respective first to third switching layers 111 to 113 can be switched independently between the color state and the translucent state.

Moreover, dielectric anisotropy of the guest host liquid crystal layer and combination of liquid crystal molecules without voltage application in the first to third switching layers 111 to 113 are arbitrary, and switching may be favorably performed between the color state and the translucent state.

On the other hand, a second counter electrode 412 is provided on an opposite surface of the intermediate member 410 to the first counter electrode 411. The second counter electrode 412 can be also based on ITO with translucency.

Furthermore, a second substrate 217 is provided opposed to the second counter electrode 412. The second substrate 217 can be illustratively based on the glass substrate with translucency. However, the substrate is not limited to this, and resin material or the like with translucency may be used. Moreover, as described later, the second substrate 217 can be also based on a substrate without translucency.

A fourth picture element electrode 231 and a fourth switching element 221 connected to it, a fifth picture element electrode 232 and a fifth switching element 222 and connected to it, and a sixth picture element electrode 233 and a sixth switching element 223 connected to it are provided on the second counter electrode 412 side of the second substrate 217.

The fourth to sixth picture element electrodes 231 to 233 can be based on a transparent electrode such as ITO or the like. The fourth to sixth switching elements 221 to 223 can be illustratively based on the thin film transistor using amorphous silicon, polysilicon and micro-crystal silicon or the like as the active layer. The fourth to sixth picture element electrodes 231 to 233 can be provided at positions corresponding to in-plane positions of the first to third picture element electrodes 131 to 133, respectively.

That is, the display device 30 is further provided with the first substrate 117 and the second substrate 217 provided opposed to the first substrate 117. Moreover, the first to third switching elements 121 to 123 and the first to third picture element electrodes 131 to 133 are provided on the surface facing the second substrate 217 of the first substrate 117. Furthermore, the fourth to sixth switching elements 221 to 223 and the fourth to sixth picture element electrodes 231 to 233 are provided on the surface facing the first substrate 117 of the second substrate 2127.

The polymer dispersed liquid crystal is illustratively provided between the respective fourth to sixth picture element electrodes 231 to 233 and the second counter electrode 412. However, the invention is not limited to this, and as described previously, various electro-optic layers switching between the reflective state and the translucent state can be used.

The electrical potential supplied to the fourth to sixth picture element electrodes 231 to 233 through the fourth to sixth switching elements 221 to 223 and the potential difference (voltage) between the second counter electrode 412 and them produce voltage which is applied to the polymer dispersed liquid crystal layers of the fourth to sixth switching layers 211 to 213, and the respective fourth to sixth switching layers 211 to 213 can be switched independently between the reflective state and the translucent state.

The first to third colored layers 311 to 313 are provided on the opposite surface of the second substrate 217 to the second counter electrode 412 at positions corresponding to respective positions of the first to third switching layers 111 to 113.

As described previously, the first to third colored layers 311 to 313 have complementary colors with respect to colors of the color state of the first to third switching layers 111 to 113, respectively, and in this case, the first to third colored layers 311 to 313 have colors of R, G, B, respectively. The first to third colored layers 311 to 313 can be illustratively provided using various methods of printing methods including offset printing of resin containing dye and pigment and ink jet printing, a transfer method and a photo-lithography method or the like.

It is noted that the invention is not limited to this, and any materials and formation methods for use are available as long as the first to third colored layers 311 to 313 are colored. Moreover, as described later, the first to third colored layers 311 to 313 may be provided between the second substrate 217 and the fourth to sixth switching layers 211 to 213.

Furthermore, as described previously, a laminated portion of the first switching layer 111, the fourth switching layer 211 and the first colored layer 311 serves as the first sub-picture element 101. Moreover, a laminated portion of the second switching layer 112, the fifth switching layer 212 and the second colored layer 312 serves as the second sub-picture element 102. Moreover, a laminated portion of the third switching layer 113, the sixth switching layer 213 and the third colored layer 313 serves as the third sub-picture element 103. Finally, one picture element 105 is formed by the first sub-picture element 101, the second sub-picture element 102 and the third sub-picture element 103.

As described previously in FIG. 8, in the display device 30, the above plurality of picture elements 105 are arranged in a regular matrix. As described previously, one picture element 105 can display white, black and respective colors, and planar arrangement of it allows the display device 30 to display any patterns in any colors.

As described above, the display device 30 according to the embodiment provides the reflective display device having the two layers structure achieving bright display of any patterns with low power consumption and high contrast.

Moreover, in the display device 30 as illustrated in FIG. 9, while a first seal section 119 bonding the first substrate 117 and the intermediate member 410, and a second seal section 219 bonding the second substrate 217 and the intermediate member 410 in the surroundings of the picture element section provided with the picture element 105, these seal sections may be provided as necessary and may be omitted.

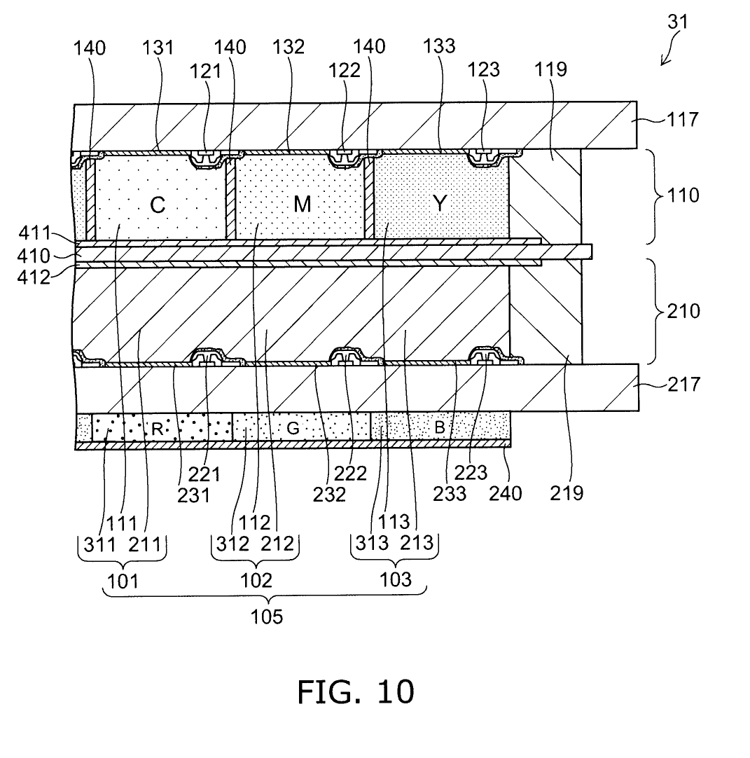

FIG. 10 is a schematic cross-sectional view illustrating the configuration of another display device according to the third embodiment of the invention.

As shown in FIG. 10, another display device 31 according to the third embodiment of the invention is provided with a reflecting layer 240 on the opposite surface of the first to third colored layers 311 to 313 to the second display layer 210 with respect to the display device 30 illustrated in FIG. 9. Other components may be similar to the display device 30, thus the description thereof is omitted.

As described previously, the first to third colored layers 311 to 313 are preferred to have reflectivity, particularly diffusive reflectivity. As illustrated in FIG. 10, providing the reflecting layer 240 in addition to the first to third colored layers 311 to 313 enables the first to third colored layers 311 to 313 to be optimized through emphasizing coloring performance, and reflecting characteristics can be achieved with the reflecting layer 240. This reflecting layer 240 can be provided with the reflecting characteristics of high performance. The reflecting layer 240 can be based on various coating materials, sheets and films or the like having diffusivity.

In the display device 31 according to the embodiment, providing the reflecting layer 240 provides the reflective display device having the two layers structure achieving bright display of any patterns with low power consumption and high contrast.

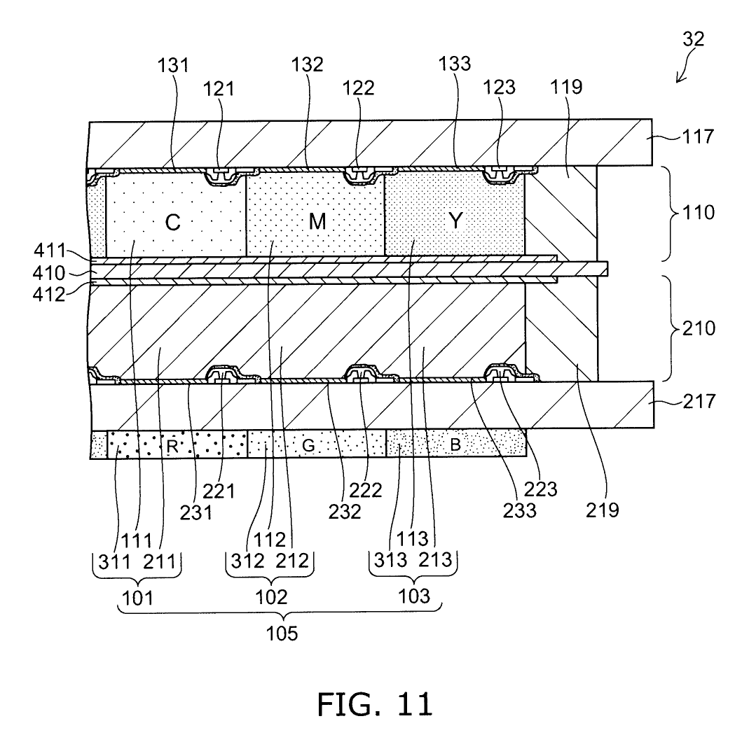

FIG. 11 is a schematic cross-sectional view illustrating the configuration of another display device according to the third embodiment of the invention.

As shown in FIG. 11, a display device 32 is based on the guest host polymer dispersed liquid crystal layer mixing liquid crystal containing dichroic dye and polymer for the first to third switching layers 111 to 113, and omits the dividing wall 140 with respect to the display device 30 illustrated in FIG. 9. Other components may be similar to the display device 30, thus the description thereof is omitted.

That is, the first switching layer 111 is based on the guest host polymer dispersed liquid crystal layer mixing liquid crystal containing dichroic dye of the C color and polymer, the second switching layer 112 is based on the guest host polymer dispersed liquid crystal layer mixing liquid crystal containing dichroic dye of the M color and polymer, and the third switching layer 113 is based on the guest host polymer dispersed liquid crystal layer mixing liquid crystal containing dichroic dye of the Y color and polymer. This allows independent switching between the color state of respective colors and the translucent state according to voltage applied to the respective switching layers.

Mixing liquid crystal containing dichroic dye and polymer eliminates mixing of guest host polymer dispersed liquid crystal of each color without dividing walls. This can omit a step of providing dividing walls.

Furthermore, the first to third switching layers 111 to 113 can be provided with mechanical stiffness and a thickness of the intermediate layer 410 can be thinned. This allows, for example, following steps. The first to third picture element electrodes 131 to 133 of the first substrate 117 have the guest host polymer dispersed liquid crystal of colors corresponding to respective electrodes printed thereon, thereafter the polymer is cross-linked, a transparent conductive film serving as the first counter electrode 411 is formed thereon, an insulating film serving as the intermediate member 410 is formed thereon, and a transparent conductive film serving as the second counter electrode 412 is formed thereon. After that, the first substrate 117 and the second substrate 217 can be assembled to form the display device. In the case where the intermediate member 410 is formed in this way, the thickness of the intermediate member 410 can be thinned, a parallax occurring for increasing mutual distances between the first to third switching layers 111 to 113, the fourth to sixth switching layers 211 to 213 and the first to third colored layers 311 to 313 can be suppressed and high quality display can be achieved.

As described above, the another display device 32 according to the embodiment provides the reflective display device having the two layers structure achieving bright and high quality display of any patterns with low power consumption and high contrast.

It is noted that, in the above, the first counter electrode 411 and the second counter electrode 412 may be unified to be one common counter electrode without providing the intermediate member 410. In this case, there is an advantage that the configuration is simplified.

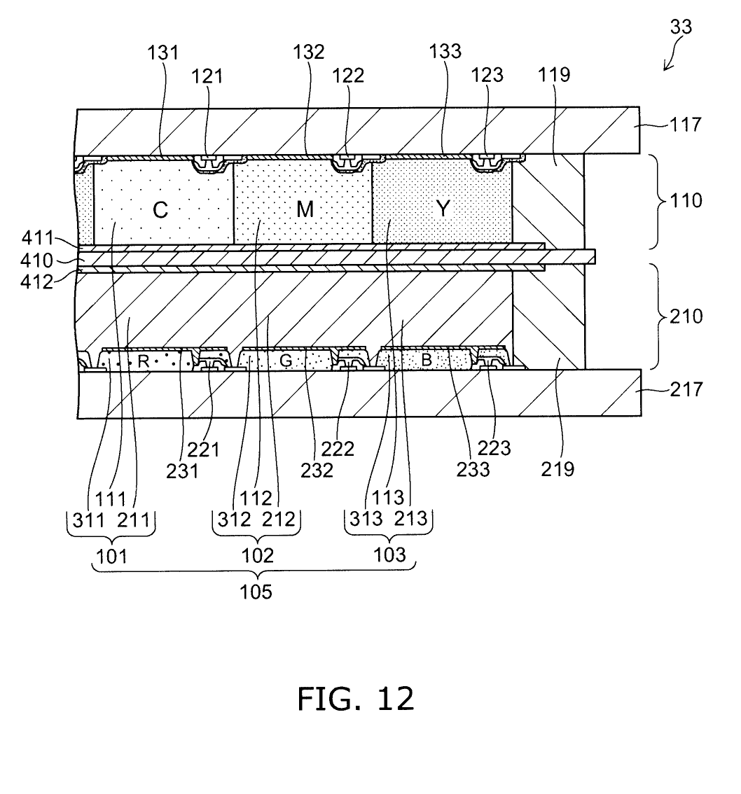

FIG. 12 is a schematic cross-sectional view illustrating the configuration of another display device according to the third embodiment of the invention.

As shown in FIG. 12, a display device 33 is provided with the first to third colored layers 311 to 313 between the second substrate 217 and the fourth to sixth switching layers 211 to 213 with respect to the display device 32 illustrated in FIG. 11. That is, the first to third colored layers 311 to 313 are provided on the surface facing the second counter electrode 412 of the second substrate 217, and the fourth to sixth picture element electrodes 231 to 233 are provided thereon. Moreover, the fourth to sixth picture element electrodes 231 to 233 can be connected to a source or a drain of the fourth to sixth switching elements 221 to 223 through a suitable through hole provided in the first to third colored layers 311 to 313. Other components may be similar to the display device 30, thus the description thereof is omitted.

That is, the display device 33 further comprises the first substrate 117 and the second substrate 217 provided opposed to the first substrate 117. The first to third switching elements 121 to 123 and the first to third picture element electrodes 131 to 133 are provided on the surface facing the second substrate 217 of the first substrate 117. The first to third colored layers 311 to 313 are provided on the surface facing the first substrate 117 of the second substrate 217. Moreover, the fourth to sixth picture element electrodes 231 to 233 are provided on sides facing the first substrate 117 of the first to third colored layers 311 to 313, respectively.

As described above, providing the first to third colored layers 311 to 313 on the side facing the second counter electrode 412 of the second substrate 217 allows the first to third colored layers 311 to 313 to be close to the first to third switching layers 111 to 113 and the fourth to sixth switching layers 211 to 213, the parallax to be suppressed and display with high quality of display to be achieved.

As described above, the another display device 33 according to the embodiment provides the reflective display device having the two layers structure achieving bright and high quality display of any patterns with low power consumption and high contrast.

Moreover, in the above, the fourth to sixth picture element electrodes 231 to 233 are provided on the first to third colored layers 311 to 313, respectively, and this makes it possible to apply voltage between the respective fourth to sixth picture element electrodes 231 to 233 and the second counter electrode 412 effectively to the fourth to sixth switching layers 211 to 213. However, if a loss due to capacitance coupling of the first to third colored layers 311 to 313 and the fourth to sixth switching layers 211 to 213 is practically negligible, and voltage of enough strength can be applied to the fourth to sixth switching layers 211 to 213, the configuration of the fourth to sixth picture element electrodes 231 to 233 and the first to third colored layers may be inversed up and down, and in this case, the parallax can be practically enough suppressed.

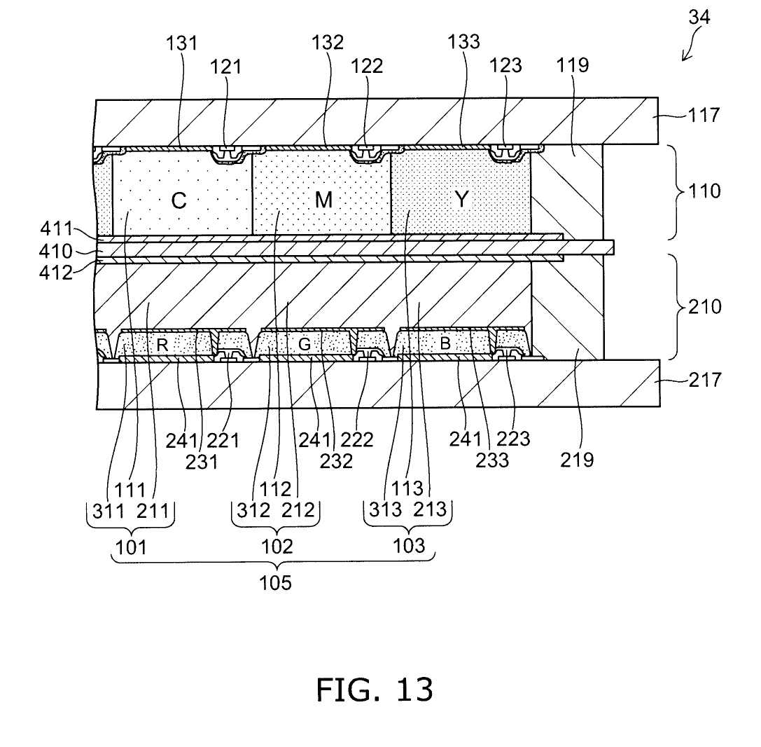

FIG. 13 is a schematic cross-sectional view illustrating the configuration of another display device according to the third embodiment of the invention.

As shown in FIG. 13, a display device 34 is provided with a reflecting layer 241 provided between the first to third colored layers 311 to 313 and the second substrate 217, with respect to the display device 33 illustrated in FIG. 12. Other components may be similar to the display device 30, thus the description thereof is omitted.

As described previously, the first to third colored layers 311 to 313 are preferred to have reflectivity, particularly diffusive reflectivity. As illustrated in FIG. 13, providing the reflecting layer 241 between the first to third colored layers and the second substrate 217 in addition to the first to third colored layers 311 to 313 enables the first to third colored layers 311 to 313 to be optimized through emphasizing coloring performance and reflecting characteristics can be achieved with the reflecting layer 241. This allows the incident light to be reflected effectively and bright and high quality display without parallax to be achieved. The reflecting layer 241 can be illustratively based on materials having fine irregularity created on a surface of metal such as aluminum or the like. However, the invention is not limited to this, and any materials, structures and formation methods for use are available as long as the reflecting characteristics are achieved.

As described above, providing the reflecting layer 241 between the first to third colored layers 311 to 313 and the second substrate 217 allows the first to third switching layers 111 to 113 and the fourth to sixth switching layers 211 to 213 to be close to the first to third colored layers 311 to 313, the parallax to be suppressed and display with high quality of display to be achieved.

As described above, the another display device 34 according to the embodiment provides the reflective display device having the two layers structure achieving bright and high quality display of any patterns with low power consumption and high contrast.

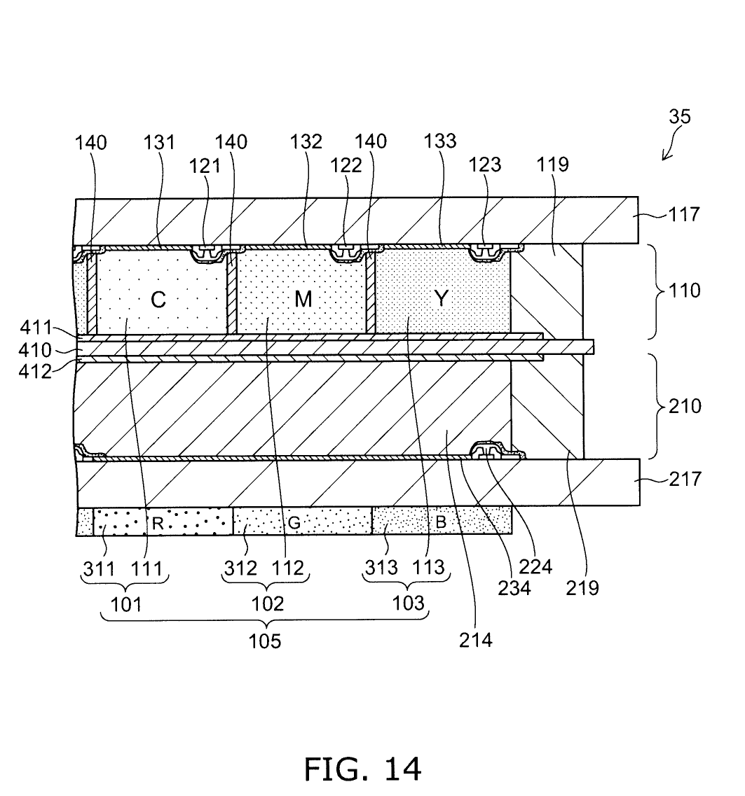

FIG. 14 is a schematic cross-sectional view illustrating the configuration of another display device according to the third embodiment of the invention.

As shown in FIG. 14, in a display device 35, the seventh switching layer 214 is used as the second display layer 210 with respect to the display device 30 illustrated in FIG. 9. That is, the seventh switching layer 214 serving as one switching layer is used every one picture element 105. Other components may be similar to the display device 30, thus the description thereof is omitted.

The seventh switching layer 214 is provided between a seventh picture element electrode 234 connected to a seventh switching element 224 and the second counter electrode 412 and switches between the reflective state and the translucent state independent of the first to third switching layers 111 to 113.

This allows various colors other than the bright white and the dark black equivalent to the display device 30 to be displayed. The display device 35 needs to provide only one picture element electrode and one switching element every one picture element 105, therefore, the display device 35 has an advantage of easy manufacturing comparing with the display device 30.

Also the another display device 35 according to the embodiment provides the reflective display device with the two layers structure achieving bright and high quality display of any patterns with low power consumption and high contrast and having easiness of manufacturing.

### Fourth Embodiment

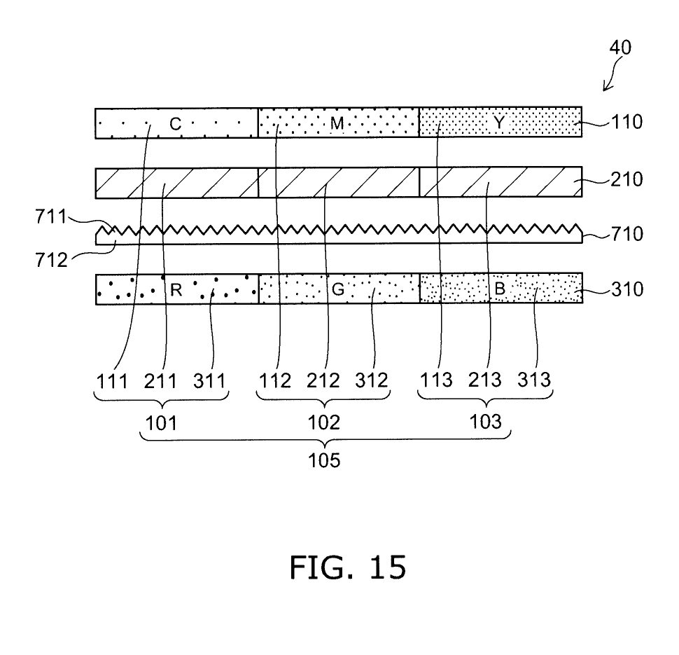

FIG. 15 is a conceptual cross-sectional view illustrating the configuration of a display device according to a fourth embodiment of the invention.

As shown in FIG. 15, a display device 40 according to the fourth embodiment of the invention further comprises a light flux control layer 710 provided between the first to third colored layers 311 to 313 and the second display layer 210.

The light flux control layer 710 can be illustratively based on a prism array sheet. The prism array sheet can be based on, for example, resin with translucency such as acryl resin and PET (Polyethylene Terephthalate) or the like. Moreover, a plurality of irregularities with triangular shaped cross section including a normal line of a first major surface 711 are provided on the first major surface 711 of the prism array sheet at a determined pitch. Furthermore, a smooth surface is provided on a second major surface 712 facing the first major surface 711. This prism array sheet has the function of totally reflecting the incident light from the first major surface 711 at the second major surface 712 and reflecting the light flux at the controlled angle within a range of definite exit angle corresponding to the shape of triangular irregularity provided on the first major surface 711.

The display device 40 illustrated in FIG. 15 is provided with the prism array sheet like this as the light flux control layer 710 between the second display layer 210 and the first to third colored layers 311 to 313, with the first major surface 711 facing the second display layer 210.

The second display layer 210 presents white as the reflective state by scattering the incident light from the outside. On this occasion, in the case where the polymer dispersed liquid crystal layer is illustratively used for the second display layer 210, reflection may not be achieved in a scattering state serving as the reflective state of the second display layer 210, because forward scattering is great and backward scattering is small with respect to the incident light.

Here, providing the prism array sheet between the second display layer 210 and the first to third colored layers 311 to 313 can reflect the light.

For example, when the second display layer 210 is in the scattering state, ideally speaking, the incident light to the second display layer 210 is effectively reflected to the first to third switching layers 111 to 113 by the backward scattering and the bright white can be achieved, but really, part of the light is transmitted to the first to third colored layers 311 to 313 side by the forward scattering in the second display layer 210. However, in the display device 40 according to the embodiment, the transmitted light can be again incident to the second display layer 210 by total reflection at the smooth surface of the prism array sheet provided between the second display layer 210 and the first to third colored layers 311 to 313. Moreover, this re-incident light is effectively scattered to the first to third switching layers 111 to 113 side by the forward scattering in the second display layer 210. This enables the display device 40 to have the enhanced reflectance of white.

Furthermore, the light flux control layer 710 can be not only based on a sheet of one dimensional prism array sheet having irregularity (groove) with triangular shaped cross section in the specified direction on the first major surface 711, but also based on the configuration achieved by doubling the two sheets of one dimensional prism array sheet having irregularity (groove) with triangular shaped cross section in the specified direction and arranging the extending direction of the irregularity in different directions (for example perpendicular). In addition, for example, a prism array sheet having two dimensionally arrayed triangular pyramid or conical irregularity with triangular shaped cross section in two different directions can be used.

Furthermore, in order to prevent color mixing by interference among adjacent sub-picture elements, an irregularity pitch of the prism array sheet can be set to the pitch of one picture element or less, namely, one-third of the arrayed pitch of the first switching layer 111 or less. However, in the case where the one dimensional prism array sheet is used as the prism array sheet, it is not limited to this, and restriction about the pitch of the prism array sheet is eased by orthogonalizing the direction of successive apexes of the prism to the direction of successive sub-picture elements, and the pitch of the irregularity of the prism array sheet may be larger than the pitch of one sub-picture element. In this case, the irregularity pitch can be the pitch of one picture element (three times of sub-picture element) or less, namely, the arrayed pitch of the first switching layer 111 or less.

The above first major surface 711 and the second major surface 712 may be placed inversely. Particularly, except the prism having an apex angle of 90°, the first major surface 711 and the second major surface 712 can be placed inversely.

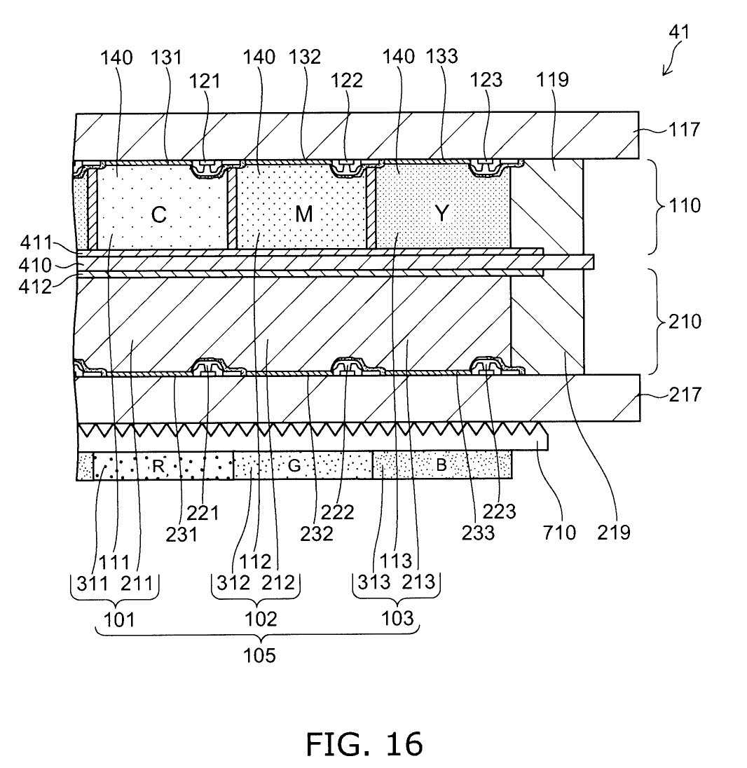

FIG. 16 is a schematic cross-sectional view illustrating the configuration of another display device according to the fourth embodiment of the invention.

As shown in FIG. 16, a display device 41 is provided with the light flux control layer 710 between the second display layer 210 and the first to third colored layers 311 to 313 with respect to the display device 30 illustrated in FIG. 9. Other components may be similar to the display device 30, thus the description thereof is omitted.

That is, the previously described prism array sheet is provided on the surface of the first to third colored layers 311 to 313 side of the second substrate 217. At this time, the first to third colored layers 311 to 313 may be provided on another substrate not shown, and may be provided on the second major surface 712 (smooth surface) of the prism array sheet.

As described above, in the display device 41, providing the light flux control layer 710 enables to improve the light use efficiency, and thereby further bright display is possible.

The another display device 41 according to the embodiment provides the reflective display device having the two layers structure achieving further bright and high quality display of any patterns with low power consumption and high contrast.

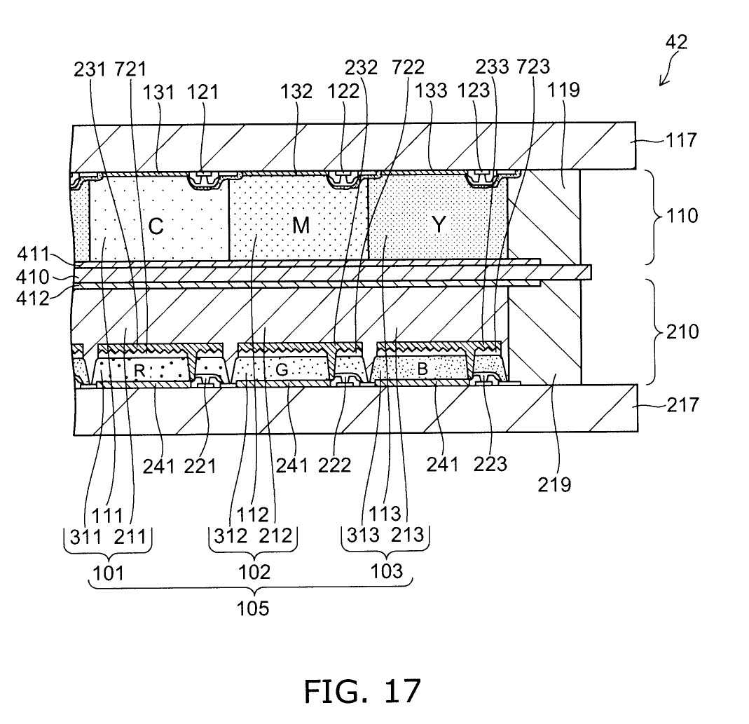

FIG. 17 is a schematic cross-sectional view illustrating the configuration of another display device according to the fourth embodiment of the invention.

As shown in FIG. 17, a display device 42 is provided with the light flux control layer 710 between the second display layer 210 and the first to third colored layers 311 to 313 with respect to the display device 34 illustrated in FIG. 13. Other components may be similar to the display device 34, thus the description thereof is omitted.

That is, first to third light flux control layers 721 to 723 are provided on the first to third colored layers 311 to 313 provided on the second substrate 217, respectively, and the fourth to sixth picture element electrodes 231 to 233 are provided thereon, respectively.

The first to third light flux control layers 721 to 723 are illustratively based on silicon dioxide with translucency, and can be illustratively provided by controlling conditions of photolithography and etching and forming a tapered shape having a cross section shape inclined to a layer plane. However, the invention is not limited to this, and any materials, structures and forming methods for use are available, if an optical layer having a shape which can control the light flux can be formed on the first to third colored layers 311 to 313.

As described above, the display device 42 can be provided with the light flux control layer 710 between the second substrate 217 and the second counter electrode 412, and thereby the first to third colored layers 311 to 313 can be close to the first to third switching layers 111 to 113 and the fourth to sixth switching layers 211 to 213, and display having the light use efficiency improved can be achieved while suppressing the parallax.

The another display device 42 according to the embodiment provides the reflective display device having the two layers structure achieving further bright and high quality display having the parallax suppressed of any patterns with low power consumption and high contrast.

Moreover, in the display device according to the above embodiment, a black matrix with light blocking effect or a white matrix with reflectivity may be provided in at least any space among the respective first to third switching layers 111 to 113, among the respective fourth to sixth switching layers 211 to 213 and among the first to third colored layers 311 to 313.

The embodiment of the invention has been described with reference to the examples. However, the invention is not limited to these examples. For example, any specific configurations of respective elements comprising the display device are also encompassed within the scope of the invention as long as a person skilled in the art may similarly work the invention by selecting as appropriate from the publicly known scope and achieve the similar effect.

Moreover, any combinations of any two or more elements in the respective examples within the technically possible range are also encompassed within the scope of the invention as long as they include the features of the invention.

All display devices which a person skilled in the art could have work by appropriate design variation on the basis of the display device described above as the embodiment of the invention also belong to the scope of the invention as long as they include the features of the invention.

In addition, a person skilled in the art could have easily made various variations and modifications within the category of the idea of the invention, and these variations and modifications are also considered to belong to the scope of the invention.

1. A display device comprising:
a first switching layer switchable between a first color state and a translucent state;
a second switching layer juxtaposed in the same plane as the first switching layer, switchable between a second color state and a translucent state independent of the first switching layer;
a third switching layer juxtaposed in the same plane as the first switching layer, switchable between a third color state and a translucent state independent of the first switching layer and the second switching layer;
a first colored layer laminated to the first switching layer, having a color serving as a complementary color with respect to a color in the first color state;
a second colored layer laminated to the second switching layer in the same plane as the first colored layer, having a color serving as a complementary color with respect to a color in the second color state;
a third colored layer laminated to the third switching layer in the same plane as the first colored layer, having a color serving as a complementary color with respect to a color in the third color state; and
an intermediate layer provided between the first switching layer and the first colored layer, between the second switching layer and the second colored layer, and between the third switching layer and the third colored layer, switchable between a reflective state and a translucent state independent of the first switching layer, the second switching layer and the third switching layer,
mixing colors in the first color state, the second color state and the third color state producing achromatic color.

2. The device according to claim 1, wherein the intermediate layer includes
a fourth switching layer provided between the first switching layer and the first colored layer, switchable between a reflective state and a translucent state,
a fifth switching layer provided between the second switching layer and the second colored layer, switchable between a reflective state and a translucent state independent of the fourth switching layer, and
a sixth switching layer provided between the third switching layer and the third colored layer, switchable between a reflective state and a translucent state independent of the fourth switching layer and the fifth switching layer.

3. The device according to claim 1, wherein the first color state exhibits a color of cyan, the second color state exhibits a color of magenta and the third color state exhibits a color of yellow.

4. The device according to claim 1, wherein the first color state exhibits a color of red, the second color state exhibits a color of green and the third color state exhibits a color of blue.

5. The device according to claim 1, wherein the first switching layer, the second switching layer and the third switching layer include a guest host liquid crystal layer.

6. The device according to claim 1, further comprising: a dividing wall provided between respective layers among the first switching layer, the second switching layer and the third switching layer.

7. The device according to claim 1, wherein
the first switching layer includes a layer mixing guest host liquid crystal of the color in the first color state and polymer,
the second switching layer includes a layer mixing guest host liquid crystal of the color in the second color state and polymer,
the third switching layer includes a layer mixing guest host liquid crystal of the color in the third color state and polymer.

8. The device according to claim 1, wherein the intermediate layer includes a layer mixing polymer and liquid crystal.

9. The device according to claim 1, wherein the first colored layer, the second colored layer and the third colored layer has diffusion reflectivity.

10. The device according to claim 1, further comprising: a reflecting layer provided on an opposite side of each of the first colored layer, the second colored layer and the third colored layer to a surface facing the second switching layer.

11. The device according to claim 1, wherein the reflecting layer has diffusion reflectivity.

12. The device according to claim 1, wherein a plurality of picture elements comprise
a first sub-picture element including the first switching layer,
a second sub-picture element including the second switching layer, and
a third sub-picture element including the third switching layer are juxtaposed.

13. The device according to claim 12, wherein in each of the picture element, the second sub-picture element is juxtaposed adjacent to the first sub-picture element and the third sub-picture element is juxtaposed adjacent to an opposite side of the second sub-picture element to the first sub-picture element.

14. The device according to claim 1, further comprising:
a first counter electrode;
a first switching element;
a first picture element electrode connected to the first switching element, facing the first counter electrode via the first switching layer;
a second switching element;
a second picture element electrode connected to the second switching element, facing the first counter electrode via the second switching layer;
a third switching element; and
a third picture element electrode connected to the third switching element, facing the first counter electrode via the third switching layer.

15. The device according to claim 2, further comprising:
a second counter electrode;
a fourth switching element;
a fourth picture element electrode connected to the fourth switching element, facing the second counter electrode via the fourth switching layer;
a fifth switching element;
a fifth picture element electrode connected to the fifth switching element, facing the second counter electrode via the fifth switching layer;
a sixth switching element; and
a sixth picture element electrode connected to the sixth switching element, facing the second counter electrode via the sixth switching layer.

16. The device according to claim 1, wherein the intermediate layer includes a seventh switching layer provided with every picture element comprising a first sub-picture element including the first switching layer, a second sub-picture element including the second switching layer and a third sub-picture element including the third switching layer, and provided between a seventh picture element electrode connected to a seventh switching element and the second counter electrode.

17. The device according to claim 14, further comprising:
a first substrate; and
a second substrate provided opposed to the first substrate,
the first to third switching elements and the first to third picture element electrodes being provided on a surface facing the second substrate of the first substrate, and
the first to third colored layers being provided on a surface facing the first substrate of the second substrate.

18. The device according to claim 17, wherein the fourth to sixth picture element electrodes are provided on a side facing the first substrate of the first to third colored layers, respectively.

19. The device according to claim 15, further comprising:
an intermediate member provided between the first to third switching layers and the intermediate layer,
the first counter electrode being provided on a surface facing the first to third switching layers of the intermediate member, and
the second counter electrode being provided on a surface facing the intermediate layer of the intermediate member.

20. The device according to claim 1, further comprising:
a light flux control layer provided between the first to third colored layers and the intermediate layer, made of translucent material,
a plurality of irregularities with triangular shaped cross section including a normal line of a surface of the intermediate layer side of the light flux control layer being provided on the surface at a determined pitch, and
a smooth surface being provided on a surface of the first to third colored layers side of the light flux control layer.

21. The device according to claim 20, wherein the pitch of the light flux control layer is an arrayed pitch of the first switching layer or less.

22. The device according to claim 20, wherein the pitch of the light flux control layer is one-third of an arrayed pitch of the first switching layer or less.
